(19) United States
(12) Patent Application Publication
(10) Pub. No.: US 2026/0063136 A1
(43) Pub. Date: Mar. 5, 2026

(54) ROTOR, ROTARY MACHINE, AND METHOD FOR ASSEMBLING ROTOR

(71) Applicant: MITSUBISHI HEAVY INDUSTRIES COMPRESSOR CORPORATION, Hiroshima-shi, Hiroshima (JP)

(72) Inventor: Takashi Oda, Hiroshima-Shi (JP)

(73) Assignee: MITSUBISHI HEAVY INDUSTRIES COMPRESSOR CORPORATION, Hiroshima-shi, Hiroshima (JP)

(21) Appl. No.: 19/106,261

(22) PCT Filed: Jun. 26, 2023
(86) PCT No.: PCT/JP2023/023660

§ 371 Date: Feb. 25, 2025

(30) Foreign Application Priority Data
Sep. 1, 2022 (JP) 2022-139224

(51) Int. Cl. F04D 29/26; F04D 17/10; F04D 29/053; F04D 29/10; F04D 29/28

(52) U.S. Cl. CPC F04D 29/266; F04D 17/10; F04D 29/053; F04D 29/102; F04D 29/284; F05D 2230/60; F05D 2260/31; F05D 2260/37

(57) ABSTRACT

A rotor includes: a shaft extending in an axial direction in which an axis extends centered on the axis; a connecting shaft connected to an end portion of the shaft on a first side in the axial direction and having a screw part formed at a tip portion of the connecting shaft; and an impeller including an impeller body formed in a disc-like shape centered on the axis and an insertion hole which is formed in a center portion of the impeller body passing through in the axial direction and through which the connecting shaft is inserted.

### TECHNICAL FIELD

The present disclosure relates to a rotor, a rotary machine, and a method for assembling a rotor.

This application claims priority based on Japanese Patent Application No. 2022-139224 filed in Japan on Sep. 1, 2022, the contents of which are incorporated herein.

### BACKGROUND ART

In a rotary machine such as a centrifugal compressor, there is an apparatus provided with an impeller for compressing a working fluid. For example, Patent Document 1 discloses a configuration of an impeller fastening structure including an impeller, a rotor shaft whose tip is inserted into a rear surface side of the impeller, and a bolt for fastening the impeller and the rotor shaft. In this configuration, a hollow tubular portion of the impeller is inserted into an inner side in a radial direction of a hollow tubular portion of the rotor shaft. An outside surface of the hollow tubular portion of the impeller and an inside surface of the hollow tubular portion of the rotor shaft are fitted to each other by interference fit. Thus, the impeller and the rotor shaft are constrained in the radial direction and a circumferential direction centered on an axis of the rotor shaft.

### CITATION LIST

### Patent Literature

Patent Document 1: JP 2010-96113 A

### SUMMARY OF INVENTION

### Technical Problem

In the configuration described in Patent Document 1, the impeller and the shaft (rotor shaft) are fitted to each other by interference fit in order to constrain the impeller and the shaft in the radial direction and the circumferential direction. However, with such a structure, it takes time to mount the impeller to the shaft.

The present disclosure provides a rotor, a rotary machine, and a method for assembling a rotor capable of improving easiness of assembly while firmly constraining an impeller and a shaft in a radial direction and a circumferential direction.

### Solution to Problem

According to the present disclosure, there are provided: a shaft extending in an axial direction in which an axis extends centered on the axis; a connecting shaft connected to an end portion of the shaft on a first side in the axial direction and having a screw part formed at a tip portion of the connecting shaft; an impeller including an impeller body formed in a disc-like shape centered on the axis and an insertion hole which is formed in a center portion of the impeller body passing through in the axial direction and through which the connecting shaft is inserted; a sleeve having a tubular shape that is disposed at a position on a second side opposite to the first side in the axial direction relative to the impeller and is fixed to the shaft in such a manner as to cover the shaft on an outer side in a radial direction based on the axis relative to the shaft; and a nut that is disposed on the first side in the axial direction relative to the impeller, and pinches and fixes the impeller together with the sleeve in the axial direction by being fastened to the screw part. A position of a sleeve end face of the sleeve facing the first side in the axial direction and a position of an impeller end face of the impeller facing the second side in the axial direction are constrained mutually in a circumferential direction around the axis and the radial direction in a state of the sleeve end face and the impeller end face being in contact with each other.

A rotary machine according to the present disclosure includes the rotor described above, and a casing that covers the rotor from an outer side in the radial direction.

A method for assembling a rotor according to the present disclosure is an assembly method of the rotor described above, the method including: fixing the sleeve to the shaft; connecting the connecting shaft to the shaft; constraining a position of the impeller end face and a position of the sleeve end face by inserting the connecting shaft into the insertion hole of the impeller from the axial direction to bring the impeller end face and the sleeve end face into contact with each other; and fastening the nut to the screw part of the connecting shaft.

### Advantageous Effects of Invention

According to the rotor, the rotary machine, and the method for assembling the rotor of the present disclosure, it is possible to improve easiness of assembly while firmly constraining the impeller and the shaft in the radial direction and the circumferential direction.

### BRIEF DESCRIPTION OF DRAWINGS

FIG. 1 is a diagram illustrating a schematic configuration of a rotary machine according to the present embodiment.

FIG. 2 is a cross-sectional view illustrating a configuration of a main section of the rotary machine.

FIG. 3 is an enlarged cross-sectional view illustrating a configuration of an end portion of a rotor of the rotary machine.

FIG. 4 is a perspective view illustrating a first fitting part formed on a sleeve of the rotor.

FIG. 5 is a diagram of the first fitting part viewed from a first side in an axial direction.

FIG. 6 is a side view illustrating a fitting state between the first fitting part and a second fitting part formed on a protruding portion of an impeller.

FIG. 7 is a diagram of the second fitting part viewed from a second side in the axial direction.

FIG. 8 is a flowchart illustrating a procedure of an assembly method of a rotor according to the present embodiment.

FIG. 9 is a diagram illustrating a step of fixing a sleeve in the assembly method of the rotor.

FIG. 10 is a diagram illustrating a step of connecting a connecting shaft in the assembly method of the rotor.

### DESCRIPTION OF EMBODIMENTS

Hereinafter, embodiments for implementing a rotor, a rotary machine, and a method for assembling a rotor according to the present disclosure will be described with reference to the accompanying drawings. However, the disclosure is not limited only to these embodiments.

### Configuration of Geared Compressor (Rotary Machine)

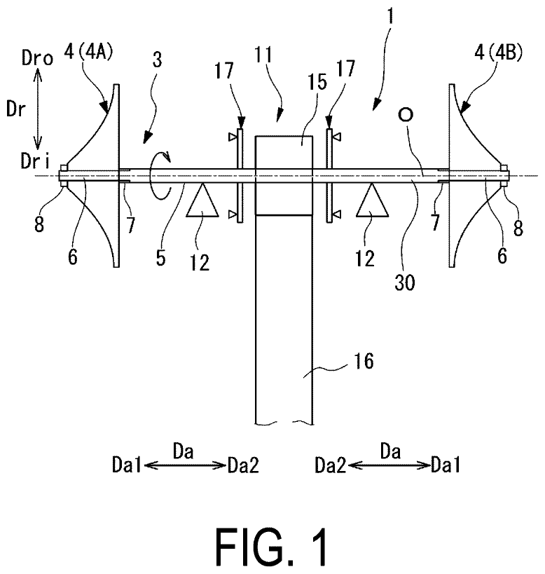

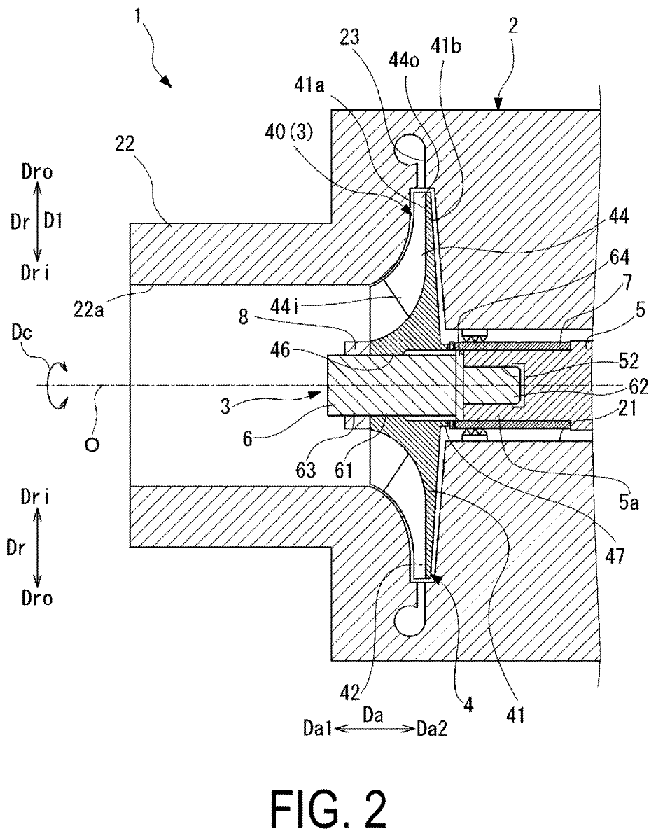

As illustrated in FIGS. 1 and 2, a geared compressor (centrifugal compressor) 1 as a rotary machine according to the present embodiment mainly includes a rotor 3, a casing 2 (see FIG. 2), a speed increase transmitter 11, a radial bearing 12, and a thrust bearing 17.

### Configuration of Rotor

The rotor 3 is rotatable about an axis O relative to the casing 2. The rotor 3 includes a shaft 5, a connecting shaft 6, a sleeve 7, an impeller 4, a nut 8, and a sealing portion 9.

The shaft 5 extends in an axial direction Da, in which the axis O extends. The shaft 5 extends centered on the axis O. As illustrated in FIG. 1, the shaft 5 is supported by a pair of radial bearings 12 to be rotatable about the axis O. The pair of radial bearings 12 is disposed at an interval in the axial direction Da. The shaft 5 is constrained from moving in the axial direction Da by a pair of thrust bearings 17. The pair of thrust bearings 17 is disposed between the pair of radial bearings 12 at positions separated on both sides in the axial direction Da relative to a pinion gear 15 described later. The pair of radial bearings 12 and the pair of thrust bearings 17 are fixed to the casing 2.

The shaft 5 is connected to an external drive source (not illustrated) such as a motor via the speed increase transmitter 11. The speed increase transmitter 11 includes the pinion gear 15 and a large-diameter gear 16. The pinion gear 15 is fixed to the shaft 5 between the pair of radial bearings 12. The large-diameter gear 16 engages with the pinion gear 15. The large-diameter gear 16 is rotationally driven by the drive source. The large-diameter gear 16 is set to have a larger outside diameter dimension than that of the pinion gear 15.

Therefore, the rotational speed of the shaft 5 fixed with the pinion gear 15 is larger than the rotational speed of the large-diameter gear 16. That is, the speed increase transmitter 11 increases, via the pinion gear 15, the rotational speed of the large-diameter gear 16 by the external drive source, and transmits the increased rotational speed to the shaft 5.

The connecting shaft 6, the sleeve 7, the impeller 4, and the nut 8 are disposed at an end portion on each side of the shaft 5 in the axial direction Da. In other words, the shaft 5 is a long member that is longest in the axial direction Da in the rotor 3. In the following description, in the geared compressor 1, a side close to an end portion of the shaft 5 of both sides in the axial direction Da is referred to as a first side Da1 in the axial direction Da, and a side away from the end portion thereof of the both sides in the axial direction Da (a side close to the pinion gear 15, a side close to a central portion of the shaft 5) is referred to as a second side Da2 in the axial direction Da. That is, relative to the pinion gear 15, the directions of the first side Da1 in the axial direction Da and the second side Da2 in the axial direction Da at one end portion of the shaft 5 in the axial direction Da are opposite to the directions of the first side Da1 in the axial direction Da and the second side Da2 in the axial direction Da at the other end portion of the shaft 5 in the axial direction Da.

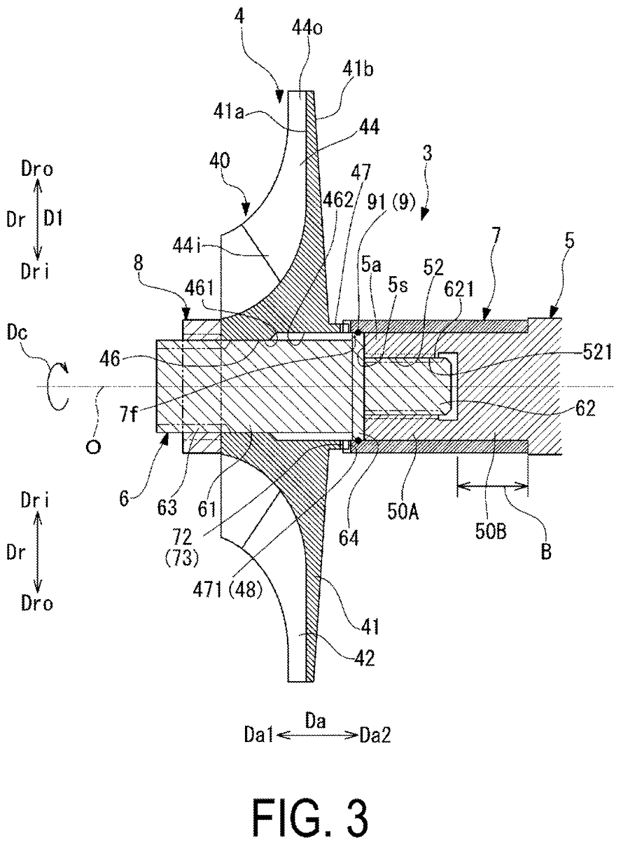

As illustrated in FIGS. 2 and 3, the shaft 5 has an insertion hole 52, into which the connecting shaft 6 is inserted. The insertion hole 52 is formed in an end portion 5a of the shaft 5 on the first side Da1 in the axial direction Da. At the end portion 5a of the shaft 5, the insertion hole 52 is recessed from a shaft end face 5s facing the first side Da1 in the axial direction Da toward the second side Da2 in the axial direction Da centered on the axis O. The insertion hole 52 is recessed from the shaft end face 5s centered on the axis O. A female thread portion 521 is formed on an inside surface of the insertion hole 52.

The shaft 5 includes, in the axial direction Da, a hole forming portion 50A having the insertion hole 52 and a solid portion 50B formed on the second side Da2 in the axial direction Da relative to the hole forming portion 50A. The hole forming portion 50A having the insertion hole 52 is formed in a tubular shape extending in the axial direction Da centered on the axis O. The solid portion 50B is not formed with the insertion hole 52, and is formed in a cylindrical shape of a solid extending in the axial direction Da centered on the axis O. In the present embodiment, the hole forming portion 50A and the solid portion 50B are integrally formed in a state where the outside surfaces thereof are smoothly connected to each other.

The connecting shaft 6 is connected to the end portion 5a of the shaft 5 on the first side Da1 in the axial direction Da. The connecting shaft 6 of the present embodiment forms an end portion of the rotor 3. The connecting shaft 6 is formed such that the length thereof in the axial direction Da is significantly shorter than that of the shaft 5. The connecting shaft 6 integrally includes a shaft body 61, an insertion shaft portion 62, a screw part 63, and a flange portion 64.

The shaft body 61 extends in the axial direction Da centered on the axis O. The shaft body 61 is formed as a cylindrical member having a smaller diameter than the shaft 5. The shaft body 61 is formed at a position overlapping the impeller 4 described later in the axial direction Da.

The insertion shaft portion 62 is formed on the second side Da2 in the axial direction Da with respect to the shaft body 61. The insertion shaft portion 62 extends from the shaft body 61 toward the second side Da2 in the axial direction Da. The insertion shaft portion 62 is formed as a cylindrical member centered on the axis O and has a smaller diameter than the shaft body 61. A male thread portion 621 is formed on the outside surface of the insertion shaft portion 62, where the outside surface faces the outer side in a radial direction Dr based on the axis O. The male thread portion 621 of the insertion shaft portion 62 is fastened by being screwed to the female thread portion 521 of the insertion hole 52. Thus, the connecting shaft 6 is connected to the end portion 5a of the shaft 5.

The flange portion 64 is formed in such a manner as to increase its diameter from the outside surface of the insertion shaft portion 62 toward an outer side Dro in the radial direction Dr. The flange portion 64 is formed on the first side Da1 in the axial direction Da with respect to the insertion shaft portion 62 in such a manner as to be adjacent to a connection position with the insertion shaft portion 62. The flange portion 64 continuously extends in the circumferential direction around the axis O centered on the axis O, and is formed in a disc-like shape when viewed from the axial direction Da. In a state where the male thread portion 621 is fastened to the female thread portion 521, the flange portion 64 is formed at a position in contact with the shaft end face 5s of the shaft 5. In other words, the flange portion 64 abuts against the shaft end face 5s of the shaft 5 from the first side Da1 in the axial direction Da.

The screw part 63 is formed at a tip portion on the first side Da1 in the axial direction Da of the connecting shaft 6. The screw part 63 extends from the shaft body 61 toward the first side Da1 in the axial direction Da. The screw part 63 includes a male thread groove on an outside surface facing the outer side Dro in the radial direction Dr.

The sleeve 7 is disposed on the second side Da2 in the axial direction Da with respect to the impeller 4. The sleeve 7 is disposed at the end portion 5a of the shaft 5 on the first side Da1 in the axial direction Da. The sleeve 7 is disposed on the outer side Dro in the radial direction Dr with respect to the shaft 5. The sleeve 7 is formed in such a manner that the length thereof in the axial direction Da is significantly shorter than that of the shaft 5. The sleeve 7 of the present embodiment is preferably formed to be substantially equal to or smaller than the connecting shaft 6 in the axial direction Da. The sleeve 7 is formed in a tubular shape extending in a circumferential direction De and has a size capable of accommodating the shaft 5 therein. The sleeve 7 is immovably fixed to the shaft 5 in a state of covering the shaft 5. The sleeve 7 is fitted to the outside surface of the shaft 5 by shrink fit. The sleeve 7 and the shaft 5 are fitted to each other by shrink fit only at a position B overlapping the solid portion 50B in the axial direction Da. The sleeve 7 has a sleeve end face 72.

The sleeve end face 72 is formed at an end portion on the first side Da1 in the axial direction Da of the sleeve 7. The sleeve end face 72 faces the first side Da1 in the axial direction Da. A first fitting part 73 described later is formed on the sleeve end face 72.

The impeller 4 is disposed in an immovable state with respect to the shaft 5, the connecting shaft 6, the sleeve 7, and the nut 8. The impeller 4 is not directly fixed to the shaft 5 and the connecting shaft 6. The impeller 4 of the present embodiment integrally includes an impeller body 40, an insertion hole 46, and a protruding portion 47.

The impeller body 40 is formed in a disc-like shape centered on the axis O. In the present embodiment, the impeller body 40 is a so-called open impeller including a disc 41 and a blade 42. The impeller body 40 may be a closed impeller having a cover.

The disc 41 has a disc-like shape, and includes a first disc surface 41a facing the first side Da1 in the axial direction Da and a second disc surface 41b facing the opposite side to the first disc surface 41a in the axial direction Da.

The second disc surface 41b is a rear surface of the impeller body 40. In the axial direction Da, the impeller body 40 is disposed such that the second disc surface 41b as the rear surface faces the second side Da2 in the axial direction Da. That is, as illustrated in FIG. 1, in a first stage impeller 4A provided at a first end of the shaft 5 and a second stage impeller 4B provided at a second end of the shaft 5, the discs 41 are disposed facing opposite directions in the axial direction Da in such a manner that the rear surfaces face each other.

As illustrated in FIG. 3, the blade 42 extends from the first disc surface 41a. A plurality of the blades 42 are disposed at intervals in the circumferential direction De around the axis O.

A working fluid (e.g., ammonia gas, air, or hydrogen gas) flows from the first side Da1 in the axial direction Da toward the second side Da2 in the axial direction Da with respect to the impeller body 40. In each impeller body 40, an impeller flow path 44 is formed between the first disc surface 41a of the disc 41 and the plurality of blades 42. The impeller flow path 44 includes an inflow port 44i and an outflow port 44o. The inflow port 44i opens to face the first side Da1 in the axial direction Da on the first side Da1 in the axial direction Da and on an inner side Dri in the radial direction Dr in the impeller body 40. In this case, the radial direction Dr is a direction centered on the axis O. The outflow port 44o opens toward the outer side Dro in the radial direction Dr on the second side Da2 in the axial direction Da and on the outer side Dro in the radial direction Dr in the impeller body 40.

The insertion hole 46 is formed passing through the impeller body 40 in the axial direction Da, and the connecting shaft 6 is inserted into the insertion hole 46. The insertion hole 46 is a through-hole formed in a center portion of the impeller body 40 and centered on the axis O. The insertion hole 46 has a first hole portion 461 formed on the first side Da1 in the axial direction Da and a second hole portion 462 formed on the second side Da2 in the axial direction Da relative to the first hole portion 461. The inside diameter of the first hole portion 461 is set to be slightly larger than the outside diameter of the shaft body 61 of the connecting shaft 6 in such a manner that a predetermined gap is formed in the radial direction Dr between the first hole portion 461 and the shaft body 61. The inside diameter of the second hole portion 462 is set to be larger than the inside diameter of the first hole portion 461. That is, a gap in the radial direction Dr formed between the second hole portion 462 and the shaft body 61 is larger than the gap in the radial direction Dr formed between the first hole portion 461 and the shaft body 61.

The protruding portion 47 protrudes from the second disc surface 41b toward the second side Da2 in the axial direction Da. The protruding portion 47 is formed in a tubular shape centered on the axis O. The protruding portion 47 is formed integrally with the impeller body 40. The inside diameter of the protruding portion 47 is equal to that of the second hole portion 462. Thus, the protruding portion 47 is formed at intervals on the outer side Dro in the radial direction Dr with respect to the connecting shaft 6 and the shaft 5. The protruding portion 47 has an impeller end face 471.

The impeller end face 471 is formed at an end portion of the protruding portion 47 on the second side Da2 in the axial direction Da. The impeller end face 471 faces the second side Da2 in the axial direction Da. A second fitting part 48 described later is formed on the impeller end face 471.

In the impeller 4 and the sleeve 7, the impeller end face 471 and the sleeve end face 72 are in contact with each other in the axial direction Da. The positions of the sleeve end face 72 and the impeller end face 471 in the circumferential direction Dc and the radial direction Dr are constrained mutually in a state of these end faces being in contact with each other.

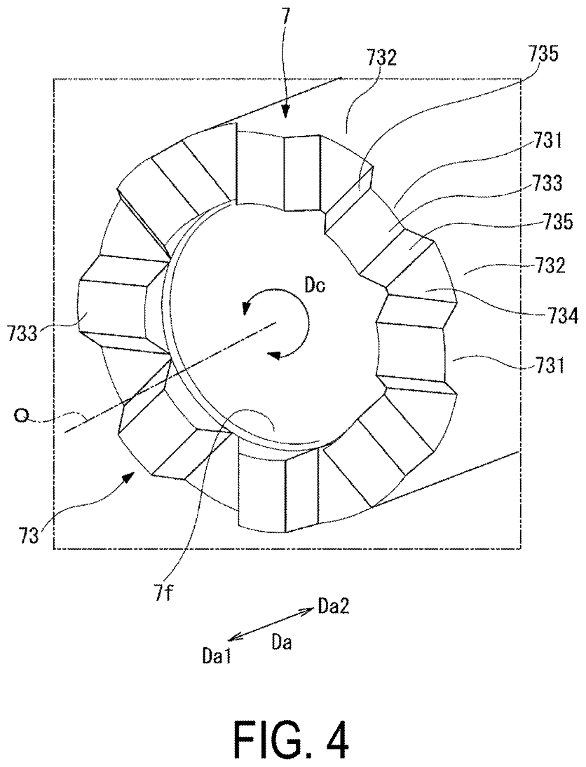

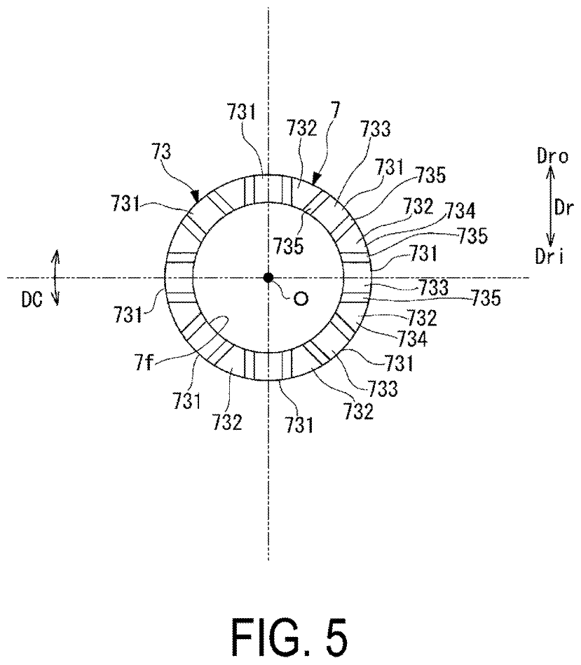

The first fitting part 73 and the second fitting part 48 are formed to be fitted to each other in a state in which the positions thereof in the circumferential direction De and the radial direction Dr are constrained mutually. As illustrated in FIGS. 4 to 6, the first fitting part 73 is formed to protrude or be recessed in the axial direction Da with respect to a surface of the sleeve 7 facing the first side Da1 in the axial direction Da. The first fitting part 73 of the present embodiment includes a plurality of (eight in the present embodiment) first protrusions 731 protruding from the sleeve end face 72 in the axial direction Da and a plurality of (eight in the present embodiment) first recesses 732 recessed therefrom in the axial direction Da. When viewed from the axial direction Da, the first fitting part 73 forms an annular region centered on the axis O on the sleeve end face 72 at a position shifted outward in the radial direction Dr with respect to the axis O.

When viewed from the axial direction Da, the first protrusions 731 and the first recesses 732 are alternately arranged in the circumferential direction Dc centered on the axis O. The first protrusion 731 protrudes from the sleeve end face 72 toward the first side Da1 in the axial direction Da. The plurality of first protrusions 731 are disposed equally separated from each other in the circumferential direction Dc. The first protrusion 731 is fitted to a second recess 482 of the impeller 4 to be described later in a state in which movements thereof in the circumferential direction Dc are mutually restricted. The first recess 732 is recessed toward the second side Da2 in the axial direction Da relative to the first protrusion 731. The plurality of first recesses 732 are disposed equally separated from each other in the circumferential direction Dc. The first recess 732 is fitted to a second protrusion 481 of the impeller 4 in a state in which movements thereof in the circumferential direction Dc and the radial direction Dr are mutually restricted.

The first fitting part 73 includes a plurality of first surfaces 733, a plurality of first separation surfaces 734, and a plurality of first connection surfaces 735. The plurality of first protrusions 731 and the plurality of first recesses 732 are formed by the plurality of first surfaces 733, the plurality of first separation surfaces 734, and the plurality of first connection surfaces 735.

The plurality of first surfaces 733 are disposed equally separated from each other in the circumferential direction Dc. The first surface 733 is a flat surface facing the first side Da1 in the axial direction Da. The first surface 733 is a top surface located farthest on the first side Da1 in the axial direction Da in the first protrusion 731.

The first separation surfaces 734 are each disposed separate from the first surface 733 in the circumferential direction De to be alternately arranged with respect to the first surface 733 when viewed from the axial direction Da. The first separation surface 734 is formed at a position shifted from the first surface 733 in the axial direction Da. The first separation surface 734 of the present embodiment is formed at a position shifted from the first surface 733 toward the second side Da2 in the axial direction Da. The first separation surface 734 is a flat surface facing the first side Da1 in the axial direction Da. The first separation surface 734 is a bottom surface located farthest on the second side Da2 in the axial direction Da in the first recess 732.

The first connection surface 735 is disposed between the first surface 733 and the first separation surface 734 adjacent to each other in the circumferential direction Dc. The plurality of first connection surfaces 735 are disposed at intervals in the circumferential direction De. Each first connection surface 735 connects the first surface 733 and the first separation surface 734. The first connection surface 735 of the present embodiment is formed as a flat surface in such a manner that a connection line with the first surface 733 and a connection line with the first separation surface 734 are straight lines radially extending in the radial direction Dr centered on the axis O when viewed from the axial direction Da. In other words, the first connection surface 735 is an inclined surface that faces the axial direction Da and the circumferential direction De and extends straight in the radial direction Dr.

The first protrusion 731 is formed by the first surface 733 and the two first connection surfaces 735 disposed at both sides of the first surface 733 in the circumferential direction Dc. The first recess 732 is formed by the first separation surface 734 and the two first connection surfaces 735 disposed at both sides of the first separation surface 734 in the circumferential direction Dc.

When viewed from the radial direction Dr, the first connection surface 735 stretches to be away from the first surface 733 in the circumferential direction De as it extends from the first side Da1 toward the second side Da2 in the axial direction Da. Accordingly, the interval between the first connection surfaces 735 disposed at both sides of the first protrusion 731 in the circumferential direction De gradually increases from the first side Da1 toward the second side Da2 in the axial direction Da when viewed from the radial direction Dr. The interval between the first connection surfaces 735 disposed at both sides of the first recess 732 in the circumferential direction De gradually decreases from the first side Da1 toward the second side Da2 in the axial direction Da when viewed from the radial direction Dr.

In the first fitting part 73, the first surface 733, the first connection surface 735, the first separation surface 734, the first connection surface 735, and the first surface 733 are repeatedly arranged in this order in the circumferential direction De to form the plurality of first protrusions 731 and the plurality of first recesses 732 in a shape like Hirth coupling.

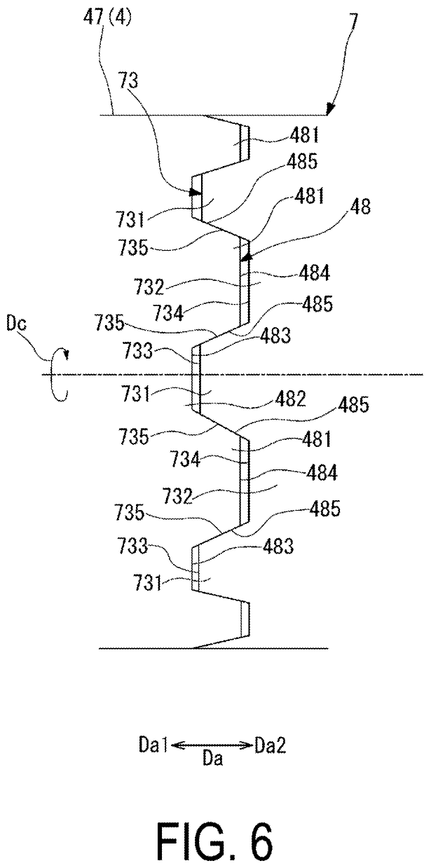

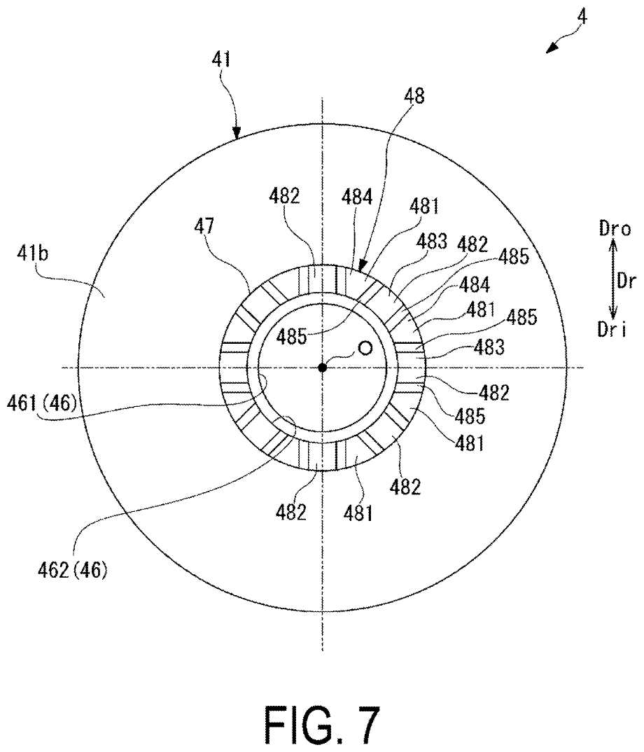

As illustrated in FIGS. 6 and 7, the second fitting part 48 is formed to protrude or be recessed in the axial direction Da with respect to a surface of the impeller 4 facing the second side Da2 in the axial direction Da. The second fitting part 48 of the present embodiment includes a plurality of (eight in the present embodiment) the second protrusions 481 protruding from the impeller end face 471 in the axial direction Da and a plurality of (eight in the present embodiment) the second recesses 482 recessed therefrom in the axial direction Da. When viewed from the axial direction Da, the second fitting part 48 forms an annular region centered on the axis O on the impeller end face 471 at a position shifted outward in the radial direction Dr with respect to the axis O.

The second fitting part 48 is formed at a position overlapping the first fitting part 73 when viewed from the axial direction Da.

When viewed from the axial direction Da, the second protrusions 481 and the second recesses 482 are alternately arranged in the circumferential direction De centered on the axis O. The second protrusion 481 protrudes from the impeller end face 471 toward the second side Da2 in the axial direction Da. The plurality of second protrusions 481 are disposed equally separated from each other in the circumferential direction Dc. The second protrusion 481 is disposed at a position overlapping the first recess 732 when viewed from the axial direction Da. The second recess 482 is recessed toward the first side Da1 in the axial direction Da relative to the second protrusion 481. The plurality of second recesses 482 are disposed equally separated from each other in the circumferential direction Dc. The second recess 482 is disposed at a position overlapping the first protrusion 731 when viewed from the axial direction Da.

The second fitting part 48 includes a plurality of second surfaces 483, a plurality of second separation surfaces 484, and a plurality of second connection surfaces 485. The plurality of second protrusions 481 and the plurality of second recesses 482 are formed by the plurality of second surfaces 483, the plurality of second separation surfaces 484, and the plurality of second connection surfaces 485.

The second surface 483 is a flat surface facing the second side Da2 in the axial direction Da. The second surface 483 is formed to have the same size as the first surface 733 when viewed from the axial direction Da. The second surface 483 is disposed at a position overlapping the first surface 733 when viewed from the axial direction Da. The second surface 483 is a bottom surface located farthest on the first side Da1 in the axial direction Da in the second recess 482.

The second separation surfaces 484 are each disposed separate from the second surface 483 in the circumferential direction Dc to be alternately arranged with respect to the second surface 483 when viewed from the axial direction Da. The second separation surface 484 is formed at a position shifted from the second surface 483 in the axial direction Da. The second separation surface 484 of the present embodiment is formed at a position shifted from the second surface 483 toward the second side Da2 in the axial direction Da. The second separation surface 484 is a flat surface facing the second side Da2 in the axial direction Da. The second separation surface 484 is formed to be smaller than the second surface 483 when viewed from the axial direction Da. The second separation surface 484 is formed to have the same size as the first separation surface 734 when viewed from the axial direction Da. The second separation surface 484 is a top surface located farthest on the second side Da2 in the axial direction Da in the second protrusion 481. The second separation surface 484 is disposed at a position overlapping the first separation surface 734 when viewed from the axial direction Da.

The second connection surface 485 is disposed between the second surface 483 and the second separation surface 484 adjacent to each other in the circumferential direction Dc. The plurality of second connection surfaces 485 are disposed at intervals in the circumferential direction Dc. Each second connection surface 485 connects the second surface 483 and the second separation surface 484. The second connection surface 485 of the present embodiment is formed as a flat surface in such a manner that a connection line with the second surface 483 and a connection line with the second separation surface 484 are straight lines radially extending in the radial direction Dr centered on the axis O when viewed from the axial direction Da. In other words, the second connection surface 485 is an inclined surface that faces the axial direction Da and the circumferential direction Dc and extends straight in the radial direction Dr. The second connection surface 485 is disposed at a position overlapping the first connection surface 735 when viewed from the axial direction Da. The second connection surface 485 is formed to have the same size as the first connection surface 735 when viewed from the axial direction Da.

The second recess 482 is formed by the second surface 483 and the two second connection surfaces 485 disposed at both sides of the second surface 483 in the circumferential direction Dc. The second protrusion 481 is formed by the second separation surface 484 and the two second connection surfaces 485 disposed at both sides of the second separation surface 484 in the circumferential direction De. Accordingly, in the second fitting part 48, the arrangement order of the second protrusion 481 and the second recess 482 in the circumferential direction De is opposite to the arrangement order of the first protrusion 731 and the first recess 732 in the circumferential direction Dc in the first fitting part 73.

When viewed from the radial direction Dr, the second connection surface 485 stretches to be away from the second surface 483 in the circumferential direction De as it extends from the first side Da1 toward the second side Da2 in the axial direction Da. Accordingly, the interval between the second connection surfaces 485 disposed at both sides of the second protrusion 481 in the circumferential direction Dc gradually decreases from the first side Da1 toward the second side Da2 in the axial direction Da when viewed from the radial direction Dr. The interval between the second connection surfaces 485 disposed at both sides of the second recess 482 in the circumferential direction De gradually increases from the first side Da1 toward the second side Da2 in the axial direction Da when viewed from the radial direction Dr.

In the second fitting part 48, the second surface 483, the second connection surface 485, the second separation surface 484, the second connection surface 485, and the second surface 483 are repeatedly arranged in this order in the circumferential direction Dc to form the plurality of second recesses 482 and the plurality of second protrusions 481 in a shape like Hirth coupling.

The positions of the sleeve end face 72 and the impeller end face 471 in the circumferential direction De and the radial direction Dr are constrained mutually by the second fitting part 48 and the first fitting part 73 fitting to each other.

In a state in which the first fitting part 73 and the second fitting part 48 are fitted to each other, the first connection surface 735 and the second connection surface 485 are in contact with each other. The first surface 733 and the second surface 483 as well as the first separation surface 734 and the second separation surface 484 may be in contact with each other in the axial direction Da or may oppose each other with a gap therebetween in the axial direction Da. It is sufficient that the plurality of first connection surfaces 735 are in contact with at least part of the plurality of second connection surfaces 485.

As illustrated in FIG. 3, the nut 8 is disposed on the first side Da1 in the axial direction Da with respect to the impeller 4. The nut 8 is fastened to the screw part 63 of the connecting shaft 6 to pinch and fix the impeller 4 together with the sleeve 7 in the axial direction Da. The nut 8 is formed in a disc-like shape centered on the axis O. The inside surface of the nut 8 is formed with a female thread groove to be screwed to a male thread groove of the screw part 63. The outside surface of the nut 8 is located on the inner side Dri in the radial direction Dr with respect to the first disc surface 41a in such a manner as not to obstruct the flow of the working fluid flowing into the impeller flow path 44.

The length of the nut 8 in the axial direction Da is formed to be shorter than that of the screw part 63 so that an end face of the screw part 63, which is a tip of the connecting shaft 6, projects. By being fastened to the screw part 63, the nut 8 is fixed to the screw part 63 in a state of pressing the impeller 4 toward the sleeve 7 in the axial direction Da.

The sealing portion 9 seals a space between the outside surface of the shaft 5 and the inside surface of the sleeve 7. The sealing portion 9 of the present embodiment includes, for example, a sealing member 91 disposed on the outer side Dro in the radial direction Dr of the flange portion 64 of the connecting shaft 6. The sealing member 91 is disposed on the outer side Dro in the radial direction Dr of the flange portion 64 of the connecting shaft 6. The sealing member 91 is held in a groove formed on the outside surface facing the outer side Dro in the radial direction Dr in the flange portion 64. The sealing member 91 extends in the circumferential direction Dc and is formed in an annular shape when viewed from the axial direction Da. The sealing member 91 is, for example, an O-ring formed of an elastically deformable rubber material. The sealing member 91 is in sliding contact with an inside surface 7f facing the inner side Dri in the radial direction in the sleeve 7. With this, the sealing portion 9 seals a space between the outside surface of the flange portion 64 and the inside surface 7f of the sleeve 7. Thus, the sealing portion 9 indirectly suppresses a situation in which the working fluid compressed by the impeller 4 passes through between the flange portion 64 and the sleeve 7 and reaches a gap between the outside surface of the shaft 5 and the inside surface of the sleeve 7 located on the second side Da2 in the axial direction Da.

### Configuration of Casing

As illustrated in FIG. 2, the casing 2 is formed to cover the rotor 3. The casing 2 is made of metal and forms an outer shell of the geared compressor 1. The casing 2 has a shaft insertion hole 21, into which the shaft 5 and the sleeve 7 are inserted, on the second side Da2 in the axial direction Da at a position where the impeller body 40 is disposed. The casing 2 includes an intake nozzle 22 and an exhaust flow path 23 around each impeller body 40.

The intake nozzle 22 allows the working fluid to flow into the interior of the casing 2. The intake nozzle 22 is formed in a tubular shape extending in the axial direction Da. A suction port 22a centered on the axis O is formed inside the intake nozzle 22. The intake nozzle 22 communicates with the outside of the casing 2 through the suction port 22a and with the inflow port 44i of the impeller flow path 44 opened toward the inner side Dri in the radial direction Dr of the impeller body 40. When the impeller body 40 rotates in the circumferential direction De around the axis O, the working fluid is sucked from the outside into the interior of the casing 2 through the suction port 22a.

The exhaust flow path 23 allows the working fluid inside the casing 2 to flow out of the casing 2. The exhaust flow path 23 is formed on the outer side Dro in the radial direction Dr of the outflow port 44o of the impeller flow path 44. The exhaust flow path 23 has a spiral shape continuous in the circumferential direction Dc.

In the geared compressor 1 described above, when the impeller body 40 rotates integrally with the shaft 5, the working fluid is sucked into the intake nozzle 22 of the casing 2 from the suction port 22a. The working fluid is taken into the impeller flow path 44 from the intake nozzle 22 through the inflow port 44i. The working fluid flows from the inflow port 44i toward the outflow port 44o by a centrifugal force generated by the impeller body 40 rotating integrally with the shaft 5. The working fluid is compressed while flowing from the inflow port 44i towards the outflow port 44o. The compressed working fluid flows out from the outflow port 44o toward the outer side Dro in the radial direction Dr to be fed into the exhaust flow path 23 on the outer side Dro in the radial direction Dr. The working fluid is further compressed while swirling around the axis O along the exhaust flow path 23.

### Procedure of Assembly Method of Rotor

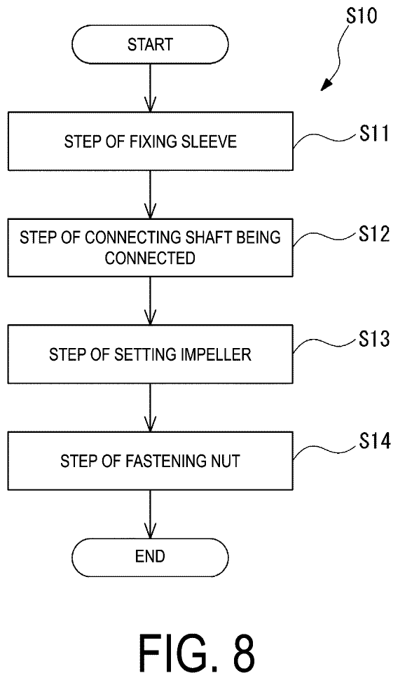

As illustrated in FIG. 8, an assembly method S10 of the rotor 3 according to the present embodiment will now be described. The assembly method S10 of the rotor 3 includes a step S11 of fixing the sleeve 7, a step S12 of connecting the connecting shaft 6, a step S13 of setting the impeller 4, and a step S14 of fastening the nut 8.

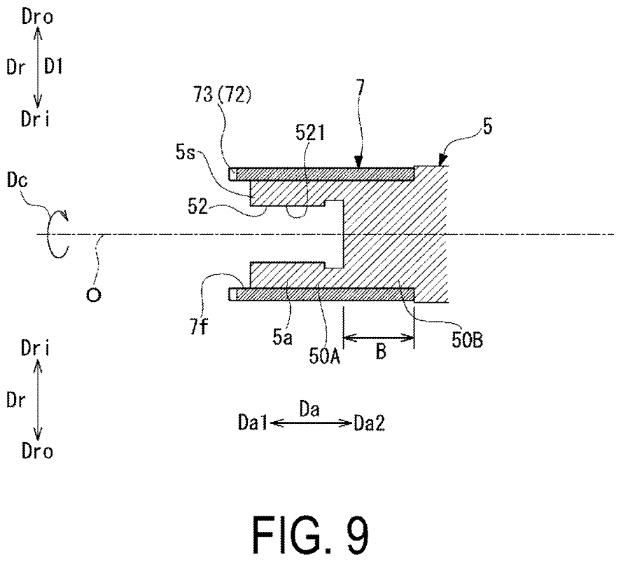

In the step S11 of fixing the sleeve 7, as illustrated in FIG. 9, the sleeve 7 is fixed to the shaft 5. The sleeve 7 is fitted to the shaft 5 by shrink fit. The sleeve 7 is subjected to shrink fit so that the sleeve 7 and the shaft 5 are fitted to each other at the position B overlapping the solid portion 50B in the axial direction Da.

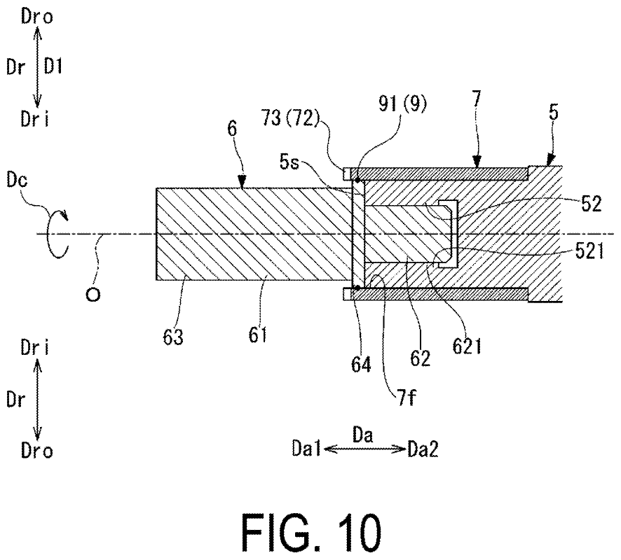

In the step S12 of connecting the connecting shaft 6, as illustrated in FIG. 10, the connecting shaft 6 is connected to the shaft 5. Specifically, the insertion shaft portion 62 is inserted deep into the insertion hole 52 while the male thread portion 621 is screwed to the female thread portion 521. At this time, the sealing member 91 is fixed to the outside surface of the flange portion 64 of the connecting shaft 6. Thereafter, the insertion shaft portion 62 is inserted into the insertion hole 52 until the flange portion 64 comes into contact with the shaft end face 5s of the shaft 5 from the first side Da1 in the axial direction Da. In this state, since the male thread portion 621 is fastened to the female thread portion 521, the connecting shaft 6 is fixed to the shaft 5 in a state immovable in the axial direction Da.

In the step S13 of setting the impeller 4, as illustrated in FIG. 3, the impeller 4 is moved with respect to the shaft 5 in such a manner that the connecting shaft 6 is inserted into the insertion hole 46 from the second side Da2 in the axial direction Da. As for the impeller 4, the connecting shaft 6 is inserted into the insertion hole 46 until the impeller end face 471 and the sleeve end face 72 come into contact with each other. The sleeve end face 72 and the impeller end face 471 are brought into contact with each other in a state where the first fitting part 73 and the second fitting part 48 are fitted to each other.

Thus, the position of the impeller 4 and the position of the sleeve 7 fixed to the shaft 5 in the circumferential direction Dc and the radial direction Dr are mutually constrained. In other words, the impeller 4 is immovable in the circumferential direction De and the radial direction Dr with respect to the shaft 5. Furthermore, in a state in which the impeller end face 471 and the sleeve end face 72 are in contact with each other, the screw part 63 is in a state of protruding toward the first side Da1 in the axial direction Da relative to the impeller 4.

In the step S14 of fastening the nut 8, the nut 8 is fastened to the screw part 63. The nut 8 causes the screw part 63 to be inserted toward a position where the impeller 4 is in a state of being pressed against the sleeve 7 in the axial direction Da. In this state, the male thread groove of the screw part 63 and the female thread groove of the nut 8 are screwed to each other, and the nut 8 is fixed to the screw part 63 in an immovable state. Thus, the nut 8 pinches and fixes the impeller 4 together with the sleeve 7 in the axial direction Da. Accordingly, the impeller 4 is fixed to the shaft 5, the connecting shaft 6, the sleeve 7, and the nut 8 in a state immovable in the axial direction Da, circumferential direction De, and radial direction Dr. In this manner, the assembly of the rotor 3 is completed.

### Operational Effects

In the rotor 3 and the rotary machine 1 configured as described above, the impeller 4 is disposed in a state in which the connecting shaft 6 connected to the end portion 5a of the shaft 5 is inserted into the insertion hole 46. In this state, the impeller 4 is pinched and fixed in the axial direction Da by the tubular sleeve 7 disposed to cover the shaft 5 and the nut 8 fastened to the screw part 63 of the connecting shaft 6. As a result, the impeller 4 is fixed to the shaft 5, the connecting shaft 6, the sleeve 7, and the nut 8 in a state immovable in the axial direction Da, circumferential direction Dc, and radial direction Dr in a state in which the impeller end face 471 and the sleeve end face 72 are in contact with each other. To be more specific, only by the contact of the sleeve end face 72 of the sleeve 7 facing the first side Da1 and the impeller end face 471 of the impeller 4 facing the second side Da2 in the axial direction Da, the positions in the circumferential direction Dc and the radial direction Dr are constrained mutually. Further, the sleeve 7 is fixed to the shaft 5 by shrink fit. As a result, the position of the impeller 4 in the circumferential direction De and the radial direction Dr is constrained with respect to the shaft 5. In this state, by fastening the nut 8 to the screw part 63, the impeller 4 is pinched between the sleeve 7 and the nut 8 to be immovable in the axial direction Da. That is, it is possible to easily attach the impeller 4 to the shaft 5 in an immovable state only by attaching the nut 8. Accordingly, while the impeller 4 and the shaft 5 are firmly constrained in the radial direction Dr and the circumferential direction De, easiness of assembly may be improved.

The shaft 5, to which the pinion gear 15 to engage with the large-diameter gear 16 is fixed, is formed as a separate member from the connecting shaft 6, the sleeve 7, and the nut 8. Therefore, it is unnecessary for the shaft 5 to have a structure for fixing the impeller 4. Accordingly, a process for enhancing tooth surface strength of the pinion gear 15, such as a carburizing process, can be performed on the shaft 5 without affecting the attachment of the impeller 4.

Further, the movements of the sleeve 7 and the impeller 4 in the circumferential direction Dc are restricted mutually by a plurality of the first fitting parts 73 and a plurality of the second fitting parts 48 disposed in the circumferential direction Dc. Further, the first fitting part 73 includes the first protrusion 731 and the first recess 732, and the second fitting part 48 includes the second protrusion 481 and the second recess 482. Then, the movement of the sleeve 7 and the movement of the impeller 4 in the circumferential direction Dc and the radial direction Dr are restricted mutually only by the fitting of the first protrusion 731 and the second recess 482 and the fitting of the first recess 732 and the second protrusion 481. Therefore, the position of the impeller 4 in the radial direction Dr with respect to the sleeve 7 can be adjusted before the position is completely fixed by the nut 8. As a result, centering of the impeller 4 with respect to the shaft 5 can be easily performed. In this way, the positions of the sleeve end face 72 and the impeller end face 471 relative to each other can be easily constrained while improving workability in assembling the rotor 3.

The first fitting part 73 to be fitted to the second fitting part 48 formed on the impeller 4 is formed not on the shaft 5 but on the sleeve 7. This makes it unnecessary to form the first fitting part 73 on the long shaft 5, thereby making it possible to suppress time for processing the shaft 5. Further, when the first fitting part 73 is formed, the sleeve 7 can be processed in a state of a single body. Therefore, compared to a case where the first fitting part 73 is formed on the shaft 5, the workability of the processing work can be improved. In a case where the first fitting part 73 is broken or the like, not the shaft 5 but the sleeve 7 as a single body can be replaced, thereby making it possible to enhance the maintainability of the rotor 3.

The first protrusion 731 is formed on the sleeve 7 by the first surface 733 and the first connection surfaces 735 disposed at both sides of the first surface 733 in the circumferential direction Dc. The first recess 732 is formed by the first separation surface 734 and the first connection surfaces 735 disposed at both sides of the first separation surface 734 in the circumferential direction De. Likewise, the second protrusion 481 is formed on the impeller 4 by the second separation surface 484 and the second connection surfaces 485 disposed at both sides of the second separation surface 484 in the circumferential direction Dc. The second recess 482 is formed by the second surface 483 and the second connection surfaces 485 disposed at both sides of the second surface 483 in the circumferential direction Dc. In a state in which the sleeve end face 72 and the impeller end face 471 are in contact with each other, the plurality of first connection surfaces 735 are in contact with at least part of the plurality of second connection surfaces 485. That is, the first protrusion 731 and the second recess 482, and the first recess 732 and the second protrusion 481 are in a state immovable in the circumferential direction Dc by the first connection surface 735 and the second connection surface 485. Therefore, the position of the impeller 4 in the radial direction Dr can be more accurately adjusted before the position is completely fixed by the nut 8. As a result, the centering of the impeller 4 with respect to the shaft 5 can be easily performed with high precision. With this, the workability in assembling the rotor 3 may be significantly enhanced.

When viewed from the radial direction Dr, the plurality of first connection surfaces 735 each stretch to be away from the first surface 733 in the circumferential direction Dc as they extend from the first side Da1 toward the second side Da2 in the axial direction Da. Accordingly, in the first protrusion 731, the interval between the first connection surfaces 735 disposed at both sides in the circumferential direction De with respect to the first surface 733 increases toward the first separation surface 734. Likewise, in the second protrusion 481, the interval between the second connection surfaces 485 disposed at both sides in the circumferential direction Dc with respect to the second surface 483 increases toward the second separation surface 484. Due to this, at the time of assembling the rotor 3, when the impeller 4 is brought close to the sleeve 7, insertion of the first protrusion 731 into the second recess 482 and insertion of the second protrusion 481 into the first recess 732 are guided by the first connection surface 735, the second connection surface 485, and the like. Therefore, even in a case where the position of the impeller 4 in the circumferential direction Dc and the radial direction Dr is deviated with respect to the sleeve 7, the position thereof in the circumferential direction Dc and the radial direction Dr is corrected by the first connection surface 735, the second connection surface 485, and the like. Thus, the impeller 4 can be easily mounted to the sleeve 7. Thus, easiness of the assembly of the rotor 3 may be further improved.

The plurality of first connection surfaces 735 and the plurality of second connection surfaces 485 are formed as flat surfaces in such a manner that the connection lines with other surfaces are straight lines. As a result, the first surface 733 and the first separation surface 734 are connected by the first connection surface 735, which is a flat surface. Likewise, the second surface 483 and the second separation surface 484 are connected by the second connection surface 485, which is a flat surface. That is, the first protrusion 731 and the first recess 732, the second protrusion 481 and the second recess 482, and the like are formed in a shape like Hirth coupling. Therefore, the first connection surface 735 and the second connection surface 485 are formed as flat surfaces that form straight lines toward the axis O when viewed from the radial direction Dr. Accordingly, the first connection surface 735 and the second connection surface 485 can be easily processed, and the workability in processing the first fitting part 73 and the second fitting part 48 can be improved.

The second fitting part 48 is formed on the protruding portion 47 protruding from the impeller body 40. This makes it possible to form the second fitting part 48 without being affected by the shape of the impeller body 40. In addition, by forming the second fitting part 48 on the protruding portion 47, it is possible to easily process the second protrusion 481 and the second recess 482 at the time of manufacturing the impeller 4 as compared to a case where the second fitting part 48 is formed on the impeller body 40. This makes it possible to suppress a situation in which the strength of the impeller body 40 is lowered, a situation in which the shape of the second fitting part 48 is limited in terms of processing, and the like. In addition, since the second fitting part 48 is formed at a position protruding from the impeller body 40, the contact state between the first fitting part 73 and the second fitting part 48 can be visually checked with ease.

The protruding portion 47 is formed at intervals on the outer side Dro in the radial direction Dr with respect to the connecting shaft 6 and the shaft 5.

That is, the thickness of the protruding portion 47 in the radial direction Dr may be suppressed. As a result, the rigidity of the protruding portion 47 is lower than that of the impeller body 40. When the impeller 4 rotates in the circumferential direction Dc together with the shaft 5 and the connecting shaft 6, a centrifugal force acts on the impeller 4. Due to the centrifugal force, deformation, displacement, or the like may occur spreading toward the outer side Dro in the radial direction Dr in the impeller body 40, the protruding portion 47, or the like. On the other hand, the second fitting part 48 is fitted to the first fitting part 73 at the impeller end face 471, whereby deformation, displacement, and the like due to the centrifugal force are restricted. In this state, the deformation, displacement, and the like of the protruding portion 47 brought about by the centrifugal force due to the lowered rigidity of the protruding portion 47 are suppressed in such a manner as to follow the restricted impeller end face 471. Therefore, it is possible to suppress a situation in which the second fitting part 48 is affected by the centrifugal force acting on the impeller 4.

The sleeve 7 and the shaft 5 are fitted to each other by shrink fit. With this, the sleeve 7 can be firmly fixed to the shaft 5 without performing a process of fixing the sleeve 7 to the shaft 5 in advance. Accordingly, the strength of the rotor 3 can be stabilized while enhancing the workability of processing work of the shaft 5.

The sleeve 7 and the shaft 5 are fitted to each other by shrink fit. When fitted by shrink fit, a fastening force toward the inner side Dri in the radial direction Dr is applied from the sleeve 7 to the shaft 5. In the shaft 5, as compared to the hole forming portion 50A formed with a space therein, the solid portion 50B, in which no space is formed, has large strength against the deformation in the radial direction Dr applied from the sleeve 7. Accordingly, by fitting the sleeve 7 and the shaft 5 to each other by shrink fit at the position B overlapping the solid portion 50B in the axial direction Da, it is possible to suppress the deformation of the shaft 5 and firmly fix the sleeve 7 to the shaft 5. In a case of performing fitting by shrink fit at a position overlapping the hole forming portion 50A, the hole forming portion 50A is deformed by the fastening force from the sleeve 7, so that it may be difficult to insert the connecting shaft 6 into the hole forming portion 50A and the insertion hole 52. In contrast, by performing fitting by shrink fit at the position B overlapping the solid portion 50B, the deformation of the insertion hole 52 can be suppressed, and easiness of the assembly of the rotor 3 can be maintained.

The sealing member 91 seals a space between the outside surface of the flange portion 64 and the inside surface 7f of the sleeve 7. That is, the sealing portion 9 can suppress a situation in which the working fluid flows into a space between the outside surface of the shaft 5 and the inside surface of the sleeve 7. Thus, in the rotary machine 1 including the rotor 3 described above, in a case where a corrosive gas is used as a working fluid, or the like, it is possible to suppress a situation in which the corrosive gas compressed by the impeller 4 reaches the shaft 5.

In addition, in the assembly method S10 of the rotor 3 including the above-discussed shaft 5, connecting shaft 6, sleeve 7, and nut 8, it is possible to improve easiness of the assembly while firmly constraining the impeller 4 and the shaft 5 in the radial direction Dr and the circumferential direction Dc at the time of assembling the rotor 3.

### Other Embodiments

Although the embodiment of the present disclosure has been described in detail with reference to the accompanying drawings, specific configurations are not limited to the embodiment, and include design modifications and the like without departing from the gist of the present disclosure.

In the above-described embodiment, as an aspect of the geared compressor 1, a so-called single-shaft two-stage configuration has been described as an example. However, the aspect of the geared compressor 1 is not limited thereto, and the geared compressor 1 may include a two-shaft four-stage configuration or a configuration of more shafts and more stages, in accordance with design, specifications, and the like.

The rotary machine of the present invention is not limited to the geared compressor 1, and may be a centrifugal compressor, a gas turbine, a steam turbine, or the like.

The sleeve 7 is not limited to the structure in which the sleeve 7 is fixed to the shaft 5 by shrink fit. As long as the sleeve 7 is fixed to the shaft 5, the sleeve 7 may be fixed by another fitting method such as cooling fit or by a fixing method using another fixing member such as a bolt.

The plurality of first connection surfaces 735 and the plurality of second connection surfaces 485 are not limited to being formed as flat surfaces in such a manner that the connection lines with other surfaces are straight lines. That is, the first protrusion 731 and the first recess 732, the second protrusion 481 and the second recess 482, and the like are not limited to being formed in a shape like Hirth coupling. For example, the plurality of first connection surfaces 735 and the plurality of second connection surfaces 485 may be formed as curved surfaces in such a manner that the connection lines with other surfaces are curved lines. That is, the first protrusion 731 and the first recess 732, the second protrusion 481 and the second recess 482, and the like may be formed in a shape like curvic coupling.

The sealing portion 9 is not limited to a structure in which it is disposed on the connecting shaft 6 like the flange portion 64 and indirectly seals a space between the outside surface of the shaft 5 and the inside surface of the sleeve 7. As for the sealing portion 9, for example, the sealing portion 9 may be directly disposed between the outside surface of the shaft 5 and the inside surface of the sleeve 7.

### Supplementary Notes

The rotor 3, the rotary machine 1, and the method for assembling the rotor 3, which are described in the embodiment, are understood as follows, for example.
(1) The rotor 3 according to a first aspect includes: the shaft 5 extending centered on the axis O in the axial direction Da, in which the axis O extends; the connecting shaft 6 connected to the end portion 5a of the shaft 5 on the first side Da1 in the axial direction Da and having the screw part 63 formed at a tip portion of the connecting shaft 6; the impeller 4 including the impeller body 40 formed in a disc-like shape centered on the axis O and the insertion hole 46, which is formed in a center portion of the impeller body 40 passing through in the axial direction Da and through which the connecting shaft 6 is inserted; the sleeve 7 having a tubular shape that is disposed at a position on the second side Da2 opposite to the first side Da1 in the axial direction Da relative to the impeller 4 and is fixed to the shaft 5 in such a manner as to cover the shaft 5 on the outer side Dro in the radial direction Dr based on the axis O relative to the shaft 5; and the nut 8, which is disposed on the first side Da1 in the axial direction Da relative to the impeller 4, and pinches and fixes the impeller 4 together with the sleeve 7 in the axial direction Da by being fastened to the screw part 63. A position of the sleeve end face 72 of the sleeve 7 facing the first side Da1 in the axial direction Da and a position of the impeller end face 471 of the impeller 4 facing the second side Da2 in the axial direction Da are constrained mutually in the circumferential direction Dc around the axis O and the radial direction Dr in a state of the sleeve end face 72 and the impeller end face 471 being in contact with each other.

Thus, the impeller 4 is fixed to the shaft 5, the connecting shaft 6, the sleeve 7, and the nut 8 in a state immovable in the axial direction Da, circumferential direction Dc, and radial direction Dr in a state in which the impeller end face 471 and the sleeve end face 72 are in contact with each other. To be more specific, only by the contact of the sleeve end face 72 of the sleeve 7 facing the first side Da1 and the impeller end face 471 of the impeller 4 facing the second side Da2 in the axial direction Da, the positions in the circumferential direction De and the radial direction Dr are constrained mutually. Furthermore, the sleeve 7 is fixed to the shaft 5. As a result, the position of the impeller 4 in the circumferential direction Dc and the radial direction Dr is constrained with respect to the shaft 5. In this state, by fastening the nut 8 to the screw part 63, the impeller 4 is pinched between the sleeve 7 and the nut 8 to be immovable in the axial direction Da. That is, it is possible to easily attach the impeller 4 to the shaft 5 in an immovable state only by attaching the nut 8. Accordingly, while the impeller 4 and the shaft 5 are firmly constrained in the radial direction Dr and the circumferential direction Dc, easiness of assembly may be improved.
(2) The rotor 3 according to a second aspect is the rotor 3 of (1), wherein the sleeve 7 includes the first fitting part 73, which is formed on the sleeve end face 72 and in which the plurality of first protrusions 731 protruding in the axial direction Da from the first surface 733 facing the first side Da1 in the axial direction Da and the plurality of first recesses 732 recessed in the axial direction Da from the first surface 733 are disposed in the circumferential direction Dc; the impeller 4 includes the second fitting part 48, which is formed on the impeller end face 471 and in which the plurality of second protrusions 481 protruding in the axial direction Da from the second surface 483 facing the second side Da2 in the axial direction Da and the plurality of second recesses 482 recessed in the axial direction Da from the second surface 483 are disposed in the circumferential direction Dc; the first protrusion 731 is fitted to the second recess 482 while mutually restricting movements in the circumferential direction De; and the first recess 732 is fitted to the second protrusion 481 while mutually restricting movements in the circumferential direction Dc.

Thus, the movement of the sleeve 7 and the movement of the impeller 4 in the circumferential direction Dc and the radial direction Dr are restricted mutually only by the fitting of the first protrusion 731 and the second recess 482 and the fitting of the first recess 732 and the second protrusion 481.

Therefore, the position of the impeller 4 in the radial direction Dr with respect to the sleeve 7 can be adjusted before the position is completely fixed by the nut 8. As a result, centering of the impeller 4 with respect to the shaft 5 can be easily performed. In this way, the positions of the sleeve end face 72 and the impeller end face 471 relative to each other can be easily constrained while improving workability in assembling the rotor 3.
(3) The rotor 3 according to a third aspect is the rotor 3 of (1) or (2), wherein the first fitting part 73 includes the plurality of first surfaces 733 facing the axial direction Da, the plurality of first separation surfaces 734 each disposed separately in the circumferential direction Dc to be alternately arranged with respect to the first surface 733 when viewed from the axial direction Da and formed at a position shifted in the axial direction Da relative to the first surface 733, and the plurality of first connection surfaces 735 each disposed between the first surface 733 and the first separation surface 734 in the circumferential direction De and connecting the first surface 733 and the first separation surface 734; the second fitting part 48 includes the plurality of second surfaces 483 facing the axial direction Da and each disposed at a position overlapping the first surface 733 when viewed from the axial direction Da, the plurality of second separation surfaces 484 each disposed at a position overlapping the first separation surface 734 when viewed from the axial direction Da and formed at the position shifted in the axial direction Da relative to the second surface 483, and the plurality of second connection surfaces 485 each disposed at a position overlapping the first connection surface 735 when viewed from the axial direction Da and connecting the second surface 483 and the second separation surface 484; and the plurality of first connection surfaces 735 are in contact with at least part of the plurality of second connection surfaces 485.

Thus, the first protrusion 731 and the second recess 482, and the first recess 732 and the second protrusion 481 are in a state immovable in the circumferential direction De by the first connection surface 735 and the second connection surface 485. Therefore, the position of the impeller 4 in the radial direction Dr can be more accurately adjusted before the position is completely fixed by the nut 8. As a result, the centering of the impeller 4 with respect to the shaft 5 can be easily performed with high precision. With this, the workability in assembling the rotor 3 may be significantly enhanced.
(4) The rotor 3 according to a fourth aspect is the rotor 3 of (3), wherein the first surface 733 is located on the first side Da1 in the axial direction Da relative to the first separation surface 734 when viewed from the radial direction Dr, and the plurality of first connection surfaces 735, when viewed from the radial direction Dr, each stretch to be away from the first surfaces 733 in the circumferential direction Dc as the plurality of first connection surfaces 735 extend from the first side Da1 toward the second side Da2 in the axial direction Da.

Accordingly, in the first protrusion 731, the interval between the first connection surfaces 735 disposed at both sides in the circumferential direction Dc with respect to the first surface 733 increases toward the first separation surface 734. Due to this, at the time of assembling the rotor 3, when the impeller 4 is brought close to the sleeve 7, insertion of the first protrusion 731 into the second recess 482 and insertion of the second protrusion 481 into the first recess 732 are guided by the first connection surface 735. Therefore, even in a case where the position of the impeller 4 in the circumferential direction Dc and the radial direction Dr is deviated with respect to the sleeve 7, the position thereof in the circumferential direction Dc and the radial direction Dr is corrected by the first connection surface 735. Thus, the impeller 4 can be easily mounted to the sleeve 7. Accordingly, easiness of the assembly of the rotor 3 may be further improved.
(5) The rotor 3 according to a fifth aspect is the rotor 3 of (2) or (3), wherein the impeller 4 includes the protruding portion 47 protruding in a tubular shape from the impeller body 40 toward the second side Da2 in the axial direction Da, and the second fitting part 48 is formed on the protruding portion 47.

This makes it possible to form the second fitting part 48 without being affected by the shape of the impeller body 40. This makes it possible to suppress a situation in which the strength of the impeller body 40 is lowered, a situation in which the shape of the second fitting part 48 is limited in terms of processing, and the like. In addition, since the second fitting part 48 is formed at a position protruding from the impeller body 40, the contact state between the first fitting part 73 and the second fitting part 48 can be visually checked with ease.
(6) The rotor 3 according to a sixth aspect is the rotor 3 of (5), wherein the protruding portion 47 is formed at intervals on the outer side Dro in the radial direction Dr with respect to the connecting shaft 6 and the shaft 5.

With this, the thickness of the protruding portion 47 in the radial direction Dr may be suppressed. As a result, the rigidity of the protruding portion 47 is lower than that of the impeller body 40. When the impeller 4 rotates in the circumferential direction Dc together with the shaft 5 and the connecting shaft 6, a centrifugal force acts on the impeller 4. Due to the centrifugal force, deformation, displacement, or the like may occur spreading toward the outer side Dro in the radial direction Dr in the impeller body 40, the protruding portion 47, or the like. On the other hand, the second fitting part 48 is fitted to the first fitting part 73 at the impeller end face 471, whereby deformation, displacement, and the like due to the centrifugal force are restricted. In this state, the deformation, displacement, and the like of the protruding portion 47 brought about by the centrifugal force due to the lowered rigidity of the protruding portion 47 are suppressed in such a manner as to follow the restricted impeller end face 471. Therefore, it is possible to suppress a situation in which the second fitting part 48 is affected by the centrifugal force acting on the impeller 4.
(7) The rotor 3 according to a seventh aspect is the rotor 3 of any one of (1) to (6), wherein the sleeve 7 and the shaft 5 are fitted to each other by shrink fit.
With this, the sleeve 7 can be firmly fixed to the shaft 5 without performing a process of fixing the sleeve 7 to the shaft 5 in advance.

Accordingly, the strength of the rotor 3 can be stabilized while enhancing the workability of processing work of the shaft 5.
(8) The rotor 3 according to an eighth aspect is the rotor 3 of (7), wherein the shaft 5 includes the hole forming portion 50A having the insertion hole 52, into which the connecting shaft 6 is inserted, and the solid portion 50B formed on the second side Da2 in the axial direction Da relative to the hole forming portion 50A; and the sleeve 7 and the shaft 5 are fitted to each other by shrink fit at a position overlapping the solid portion 50B in the axial direction Da.

Thus, deformation of the shaft 5 may be suppressed, and the sleeve 7 may be firmly fixed to the shaft 5. In a case of performing fitting by shrink fit at a position overlapping the hole forming portion 50A, the hole forming portion 50A is deformed by the fastening force from the sleeve 7, so that it may be difficult to insert the connecting shaft 6 into the hole forming portion 50A and the insertion hole 52. In contrast, by performing fitting by shrink fit at a position overlapping the solid portion 50B, the deformation of the insertion hole 52 can be suppressed, and easiness of the assembly of the rotor 3 can be maintained.
(9) The rotor 3 according to a ninth aspect is the rotor 3 of any one of (1) to (8), the rotor 3 further including the sealing portion 9 configured to seal a space between the outside surface of the shaft 5 and the inside surface of the sleeve 7.

Thus, in the rotary machine 1 including the rotor 3 described above, in a case where a corrosive gas is used as a working fluid, or the like, it is possible to suppress a situation in which the corrosive gas compressed by the impeller 4 reaches the shaft 5.
(10) The rotary machine 1 according to a tenth aspect includes the rotor 3 of any one of (1) to (9), and the casing 2 configured to cover the rotor 3 from the outer side Dro in the radial direction Dr.

This makes it possible to provide the rotary machine 1 including the rotor 3 capable of firmly constraining the impeller 4 and the shaft 5 in the radial direction Dr and the circumferential direction Dc.
(11) A method for assembling the rotor 3 according to an eleventh aspect is an assembly method of the rotor 3 of any one of (1) to (9), the method including: the step S11 of fixing the sleeve 7 to the shaft 5; the step S12 of connecting the connecting shaft 6 to the shaft 5; the step S13 of constraining a position of the impeller end face 471 and a position of the sleeve end face 72 by inserting the connecting shaft 6 into the insertion hole 46 of the impeller 4 from the axial direction Da to bring the impeller end face 471 and the sleeve end face 72 into contact with each other; and the step S14 of fastening the nut 8 to the screw part 63 of the connecting shaft 6.

Accordingly, while the impeller 4 and the shaft 5 are firmly constrained in the radial direction Dr and the circumferential direction De, easiness of the assembly may be improved at the time of assembling the rotor 3.

### Industrial Applicability

According to the rotor, the rotary machine, and the method for assembling the rotor of the present disclosure, it is possible to improve easiness of assembly while firmly constraining the impeller and the shaft in the radial direction and the circumferential direction.

### Reference Signs List

1 Geared compressor (Rotary machine)
2 Casing
3 Rotor
4 Impeller
4A First stage impeller
4B Second stage impeller
5 Shaft
5a End portion
5s Shaft end face
6 Connecting shaft
7 Sleeve
7f Inside surface
8 Nut
9 Sealing portion
11 Speed increase transmitter
12 Radial bearing
15 Pinion gear
16 Large-diameter gear
17 Thrust bearing
21 Shaft insertion hole
22 Intake nozzle
22a Suction port
23 Exhaust flow path
40 Impeller body
41 Disc
41a First disc surface
41b Second disc surface
42 Blade
44 Impeller flow path
44i Inflow port
44o Outflow port
46 Insertion hole
461 First hole portion
462 Second hole portion
47 Protruding portion
471 Impeller end face
48 Second fitting part
481 Second protrusion
482 Second recess
483 Second surface
484 Second separation surface
485 Second connection surface
50A Hole forming portion
50B Solid portion
52 Insertion hole
521 Female thread portion
61 Shaft body
62 Insertion shaft portion
63 Screw part
64 Flange portion
72 Sleeve end face
73 First fitting part
731 First protrusion
732 First recess
733 First surface
734 First separation surface
735 First connection surface
91 Sealing member
621 Male thread portion
Da Axial direction
Da1 First side
Da2 Second side
Dc Circumferential direction
Dr Radial direction
Dri Inner side
Dro Outer side
O Axis
S10 Assembly method of rotor
S11 Step of fixing sleeve
S12 Step of connecting shaft being connected
S13 Step of setting impeller
S14 Step of fastening nut

1. A rotor comprising:
a shaft extending in an axial direction in which an axis extends centered on the axis;
a connecting shaft connected to an end portion of the shaft on a first side in the axial direction and having a screw part formed at a tip portion of the connecting shaft;
an impeller including an impeller body formed in a disc-like shape centered on the axis and an insertion hole which is formed in a center portion of the impeller body passing through in the axial direction and through which the connecting shaft is inserted;
a sleeve having a tubular shape that is disposed at a position on a second side opposite to the first side in the axial direction relative to the impeller and is fixed to the shaft in such a manner as to cover the shaft on an outer side in a radial direction based on the axis relative to the shaft; and
a nut that is disposed on the first side in the axial direction relative to the impeller, and pinches and fixes the impeller together with the sleeve in the axial direction by being fastened to the screw part, wherein
a position of a sleeve end face of the sleeve facing the first side in the axial direction and a position of an impeller end face of the impeller facing the second side in the axial direction are constrained mutually in a circumferential direction around the axis and the radial direction in a state of the sleeve end face and the impeller end face being in contact with each other.

2. The rotor according to claim 1, wherein
the sleeve includes a first fitting part which is formed on the sleeve end face and in which a plurality of first protrusions protruding in the axial direction from a first surface facing the first side in the axial direction and a plurality of first recesses recessed in the axial direction from the first surface are disposed in the circumferential direction,
the impeller includes a second fitting part which is formed on the impeller end face and in which a plurality of second protrusions protruding in the axial direction from a second surface facing the second side in the axial direction and a plurality of second recesses recessed in the axial direction from the second surface are disposed in the circumferential direction,
the first protrusion is fitted to the second recess while mutually restricting movements in the circumferential direction, and
the first recess is fitted to the second protrusion while mutually restricting movements in the circumferential direction.

3. The rotor according to claim 2, wherein
the first fitting part includes
a plurality of the first surfaces facing the axial direction,
a plurality of first separation surfaces each disposed separately in the circumferential direction to be alternately arranged with respect to the first surface when viewed from the axial direction and formed at a position shifted in the axial direction relative to the first surface, and
a plurality of first connection surfaces each disposed between the first surface and the first separation surface in the circumferential direction and connecting the first surface and the first separation surface,
the second fitting part includes
a plurality of the second surfaces facing the axial direction and each disposed at a position overlapping the first surface when viewed from the axial direction,
a plurality of second separation surfaces each disposed at a position overlapping the first separation surface when viewed from the axial direction and formed at the position shifted in the axial direction relative to the second surface, and
a plurality of second connection surfaces each disposed at a position overlapping the first connection surface when viewed from the axial direction and connecting the second surface and the second separation surface, and
the plurality of first connection surfaces are in contact with at least part of the plurality of second connection surfaces.

4. The rotor according to claim 3, wherein
the first surface is located on the first side in the axial direction relative to the first separation surface when viewed from the radial direction, and
the plurality of first connection surfaces, when viewed from the radial direction, each stretch to be away from the first surface in the circumferential direction as the plurality of first connection surfaces extend from the first side toward the second side in the axial direction.

5. The rotor according to claim 2, wherein
the impeller includes a protruding portion protruding in a tubular shape from the impeller body toward the second side in the axial direction, and
the second fitting part is formed on the protruding portion.

6. The rotor according to claim 5, wherein the protruding portion is formed at intervals on the outer side in the radial direction with respect to the connecting shaft and the shaft.

7. The rotor according to claim 1, wherein the sleeve and the shaft are fitted to each other by shrink fit.

8. The rotor according to claim 7, wherein
the shaft includes
a hole forming portion having an insertion hole into which the connecting shaft is inserted, and
a solid portion formed on the second side in the axial direction relative to the hole forming portion, and
the sleeve and the shaft are fitted to each other by shrink fit at a position overlapping the solid portion in the axial direction.

9. The rotor according to claim 1, further comprising:
a sealing portion configured to seal a space between an outside surface of the shaft and an inside surface of the sleeve.

10. A rotary machine, comprising:
the rotor according to claim 1; and
a casing configured to cover the rotor from the outer side in the radial direction.

11. A method for assembling the rotor according to claim 1, the method comprising:
fixing the sleeve to the shaft;
connecting the connecting shaft to the shaft;
constraining a position of the impeller end face and a position of the sleeve end face by inserting the connecting shaft into the insertion hole of the impeller from the axial direction to bring the impeller end face and the sleeve end face into contact with each other; and
fastening the nut to the screw part of the connecting shaft.
